(19) United States
(12) Patent Application Publication
(10) Pub. No.: US 2025/0045997 A1
(43) Pub. Date: Feb. 6, 2025

(54) SCALABLE SOFT BODY LOCOMOTION

(71) Applicant: Roblox Corporation, San Mateo, CA (US)

(72) Inventors: Victor B. ZORDAN, Riverside, CA (US); Otman BENCHEKROUN, Toronto (CA); Hsueh-Ti Derek LIU, Burnaby (CA); Sheldon Paul ANDREWS, Hudson (CA)

(73) Assignee: Roblox Corporation, San Mateo, CA (US)

(21) Appl. No.: 18/788,816

(22) Filed: Jul. 30, 2024

Related U.S. Application Data
(60) Provisional application No. 63/530,934, filed on Aug. 4, 2023.

(51) Int. Cl. G06T 13/40; G06T 17/20

(52) U.S. Cl. CPC G06T 13/40; G06T 17/20

(57) ABSTRACT

Some implementations relate to methods, systems, and computer-readable media to provide scalable soft body locomotion/animation for a virtual experience, such as a three-dimensional (3D) environment. In some implementations, the method includes building a control space having information representative of forces corresponding to natural movement of the soft body, wherein the soft body is part of a virtual environment, coupling the control space and a physical space to define a controller pipeline that performs animation of the soft body, performing the animation of the soft body using the controller pipeline, and causing the animation of the soft body to be displayed in a user interface of the virtual environment. Building the control space may comprise simulating the forces corresponding to the natural movement of the soft body by solving an elastodynamic optimization problem using auxiliary variables as degrees of freedom.

### CROSS-REFERENCE TO RELATED APPLICATIONS

This application claims priority to U.S. Provisional Application No. 63/530,934, entitled “SCALABLE SOFT BODY LOCOMOTION,” filed on Aug. 4, 2023, the content of which is incorporated herein in its entirety.

### TECHNICAL FIELD

Implementations relate generally to computer graphics, and more particularly but not exclusively, relate to methods, systems, and computer readable media to animate or otherwise provide locomotion to perform graphical representations of bodies in a three-dimensional (3D) virtual environment.

### BACKGROUND

Deformable objects bring virtual three-dimensional (3D) environments and other types of virtual experiences to life. Traditional physics-based character controller pipelines are primarily designed for rigid characters, thereby limiting the possible morphology of the character and the controller style. Extending these controllers to work on deformable characters quickly runs into problems. The high dimensionality of such problems makes the overall process prohibitively slow and difficult to control.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of this application relate to providing locomotion for graphical representations of soft bodies. For example, the implementations uses a variety of techniques to provide effective representations of how soft bodies deform. These techniques may include creating a control space having associated information representing forces corresponding to natural movement of the soft body and coupling the control space with a physical space. This coupling yields a controller pipeline that provides an efficient soft body controller.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to animate a soft body is provided, the computer-implemented method comprising: building a control space having information representative of forces corresponding to natural movement of the soft body, wherein the soft body is part of a virtual environment; coupling the control space and a physical space to define a controller pipeline that performs animation of the soft body; performing the animation of the soft body using the controller pipeline; and causing the animation of the soft body to be displayed in a user interface of the virtual environment.

Various implementations of the computer-implemented method are described herein.

In some implementations, building the control space is based on eigenfunctions of elastic energy of the soft body.

In some implementations, the forces corresponding to the natural movement of the soft body are forces that arise from rotational stresses within the soft body.

In some implementations, the forces corresponding to the natural movement of the soft body are contact forces applied to the soft body from one or more other bodies that are part of the virtual environment.

In some implementations, building the control space comprises simulating the forces corresponding to the natural movement of the soft body by solving an elastodynamic optimization problem using auxiliary variables as degrees of freedom.

In some implementations, the simulating comprises: using a subspace approximation for the degrees of freedom; and rewriting the elastodynamic optimization problem in terms of reduced space degrees of freedom of the subspace approximation.

In some implementations, the simulating further comprises, after the rewriting, solving the elastodynamic optimization problem using a local-global solver that solves for one degree of freedom at a time while other degrees of freedom in the subspace approximation are fixed.

In some implementations, the subspace approximation comprises a positional subspace, a rotation subspace, and a subspace matrix.

In some implementations, the positional subspace is a linear blend subspace, and the computer-implemented method further comprises constructing the positional subspace by sampling point handles from a mesh of the soft body and performing a heat-diffusion from each point handle to obtain skinning weights associated with the soft body.

In some implementations, the computer-implemented method further comprises forming the rotation subspace by clustering tetrahedra in the positional subspace together using k-means clustering on the positional subspace, wherein tetrahedra in each cluster share a same rotation matrix.

In some implementations, the subspace matrix is a selection matrix that slices out randomly sampled point vertices of the soft body, wherein the randomly sampled point vertices are used to detect and resolve collisions during the animation of the soft body.

In some implementations, coupling the control space and the physical space comprises representing the physical space by addition of a linear term in an energy minimization equation when solving the elastodynamic optimization problem, the linear term comprising a matrix used to project a force subspace to corresponding effects of the force subspace on the positional subspace.

In some implementations, the controller pipeline is associated with time-varying state-dependent values for controller activations that achieve specific animation task objectives and a controller of the controller pipeline is trained using reinforcement learning to achieve the specific animation task objectives when performing animation of the soft body.

In some implementations, the control space is built based on control functions that minimize a Taylor expanded energy of the soft body and that generate a non-null set of solution control functions that are orthogonal to each other.

In some implementations, the control space is built using the solution control functions to define forces that form a basis of the control space based on a user selection of one or more selected forces of the forces that form the basis of the control space, wherein the selected forces are placed as columns of a control space matrix that represents the control space.

According to another aspect, a non-transitory computer-readable medium is provided. The non-transitory computer-readable medium with instructions stored thereon that, responsive to execution by a processing device, causes the processing device to perform operations comprising: building a control space having information representative of forces corresponding to natural movement of a soft body, wherein the soft body is part of a virtual environment; coupling the control space and a physical space to define a controller pipeline that performs animation of the soft body; performing the animation of the soft body using the controller pipeline; and causing the animation of the soft body to be displayed in a user interface of the virtual environment.

Various implementations of the non-transitory computer-readable medium are described herein.

In some implementations, building the control space is based on eigenfunctions of elastic energy of the soft body.

In some implementations, building the control space comprises simulating the forces corresponding to the natural movement of the soft body by solving an elastodynamic optimization problem using auxiliary variables as degrees of freedom.

According to another aspect, a system is disclosed, comprising: a memory with instructions stored thereon; and a processing device, coupled to the memory, the processing device configured to access the memory, wherein the instructions when executed by the processing device cause the processing device to perform operations including: building a control space having information representative of forces corresponding to natural movement of a soft body, wherein the soft body is part of a virtual environment; coupling the control space and a physical space to define a controller pipeline that performs animation of the soft body; performing the animation of the soft body using the controller pipeline; and causing the animation of the soft body to be displayed in a user interface of the virtual environment.

Various implementations of the system are described herein.

In some implementations, building the control space is based on eigenfunctions of elastic energy of the soft body.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture that includes a three-dimensional (3D) environment platform that can support the animation of soft bodies, in accordance with some implementations.

FIG. 2 illustrates example animations of a soft body, in accordance with some implementations.

FIG. 3 illustrates an example method to animate a graphical representation of a soft body in a 3D environment, in accordance with some implementations.

FIG. 4 illustrates an example method to perform subspace soft body simulation, in accordance with some implementations.

FIG. 5 illustrates an example method to build a control space, in accordance with some implementations.

FIG. 6 illustrates an example method to couple the control space with the physical space, in accordance with some implementations.

FIG. 7 illustrates an example method to train a controller, in accordance with some implementations.

FIG. 8 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, a scalable and controllable pipeline for creating soft body controllers.

Due to robustness in representing non-linear controller behaviors, reinforcement learning (RL) has been the de-facto approach for designing physics-based rigid character controllers in graphics over the last decade. However, RL is vulnerable to the additional burdens incurred by a high dimensionality soft-body simulator. RL involves exploring the space of possible controls via frequent evaluation in a simulated environment, thereby quickly becoming intractable for higher resolution characters, including avatar bodies or other types of graphical objects/representations.

All materials in the world are deformable. However, most character controllers proposed in graphics assume articulated rigid character morphologies. This assumption limits both the type of character and the controller to adhere to this block-like, rigid morphology. Naively developing a design to generate a controller for a soft body immediately brings its own set of challenges.

The first challenge is that many controller optimizers involve frequent simulation of the character in a physical environment. Stepping up from a rigid body simulation to a soft body simulation radically increases the complexity of the simulation step and becomes prohibitively expensive, especially for highly detailed meshes.

The implementations disclosed herein start from the projective dynamics formulation to provide an efficient method for simulating deformable objects with contact forces. To fully decouple the simulation from the mesh resolution, a subspace composed of three different reduced approximations, for each of the degrees of freedom: the displacements, the rotation forces, and the contact forces, is provided. The result is a real-time soft body simulation with contact that is decoupled entirely from the mesh resolution.

The second challenge is that characters are ordinarily restricted to motion allowed by their musculature. While articulated rigid characters often have musculatures actuated by joint torques located between pairs of bones, defining an equivalent musculature system automatically for a soft body is not trivial. Relying on a user or artist to do this manually is burdensome.

Accordingly, the implementations disclosed herein adopt the longitudinal muscle. To help design the musculature, the techniques infer that the geometry of a character ordinarily reflects aspects of the preferred motion of the character.

The many degrees of freedom in soft bodies further complicate the creation of an impactful control space for the controller. Ordinary rigidly articulated characters have joint torques automatically applied between neighboring rigid bones, whereas a soft-body mesh does not necessarily have an equivalent obvious structure to define a control action space. This aspect places a burden on a user to place muscles or joints manually, which is a tedious and time-consuming process.

Alternative approaches provide certain techniques used for general soft body controllers. Some approaches propose soft body controllers based on trajectory optimization that are designed to make the character maximize an objective while respecting the constraint that the motion respects the laws of physics. Unfortunately, running this optimization problem every time step is costly. Such an approach scales in complexity with the resolution of the mesh, thereby making these controllers unusable for real-time applications.

Instead, reinforcement learning (RL) based state-dependent controllers, which can be evaluated at interactive rates, are other alternative techniques. However, these techniques only provide results on very low resolution meshes (for example, less than 1200 vertices), which is a direct result of the soft body simulation being a big bottleneck for the initial training step involved with such controllers.

Similar problems arise in the space of rigid-body motion controllers. Another alternative technique reduces the control space of joint activations by approximating the control space with a smaller set of joint-coactivations, obtained via principal component analysis. Such a technique then feeds these co-activations as the control space to an RL policy. Similarly, another alternative technique builds a reduced basis of reduced character motions from the natural vibrations of their skeleton to accelerate their open loop covariance matrix adaptation evolution strategy (CMA-ES) controller.

According to the implementations disclosed herein, a method is provided wherein the control space is obtained through the natural vibrations of the high dimensional geometry, and the actual simulation is carried out in a reduced space. Such implementations are agnostic to the type of controller used.

To address the problem of scalability, the implementations disclosed herein are based at least in part on linear model reduction techniques for deformable simulation, and training RL controllers for soft characters in a reduced-space soft body simulation environment.

On the basis that the elastic properties of the mesh encode information on how a character moves, the disclosed implementations automatically build a control space based on the eigenfunctions of the elastic energy. A set of control forces that correspond to the natural vibrations of the mesh can then be provided to a user as an intuitive control space to allow the user to select which deformations that the character are to exhibit, without asking the user to manually design deformations.

A general pipeline for a scalable soft body controller uses two distinct spaces that are automatically computable, yet user modifiable: a physical space and a control space. Such a pipeline can form the backbone of character controllers.

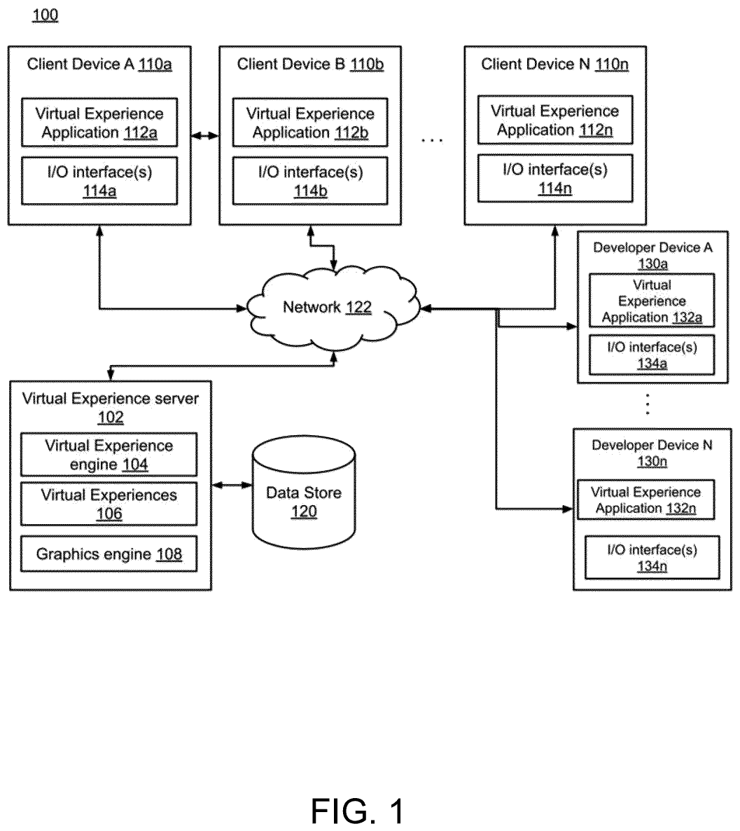

### FIG. 1—System Architecture

FIG. 1 is a diagram of an example system architecture that includes a 3D environment platform that can support the animation of soft bodies, in accordance with some implementations.

FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

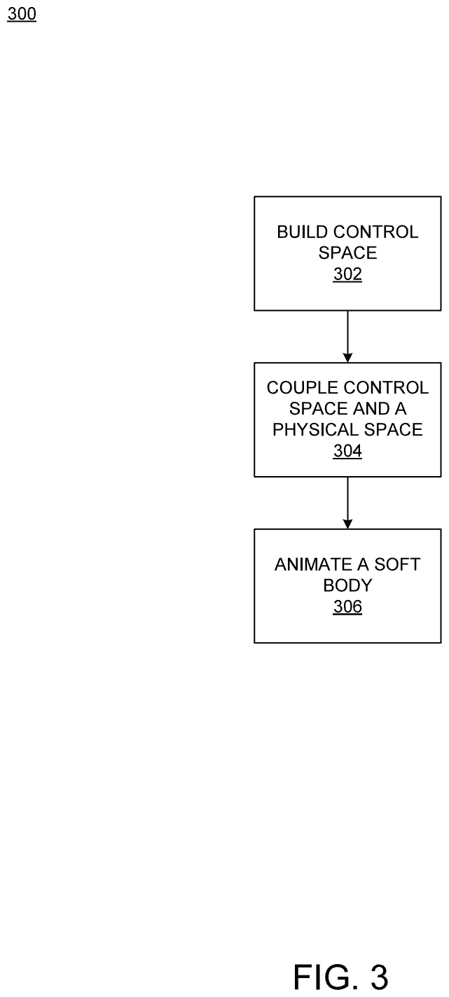

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowcharts shown in FIGS. 3-7. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

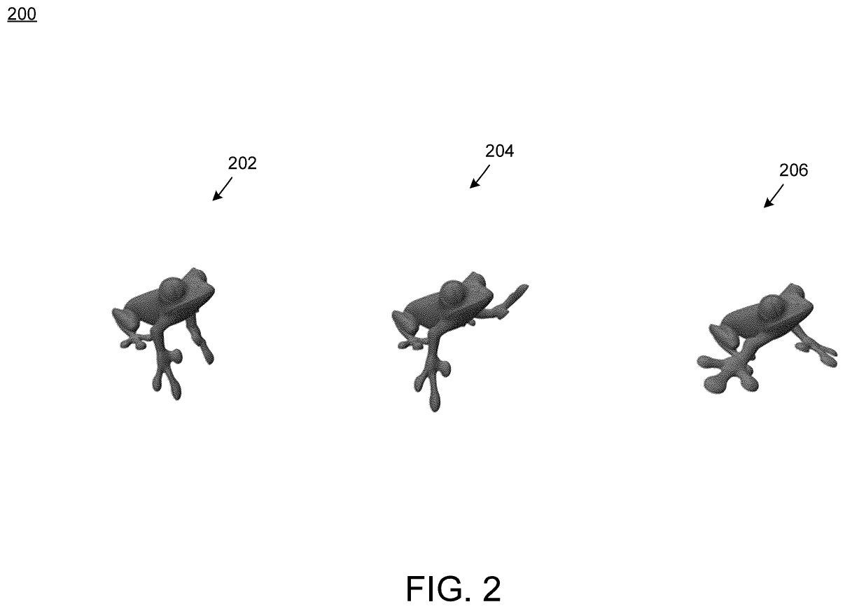

### FIG. 2—Example Animations of a Soft Body

FIG. 2 illustrates example animations of a soft body 200, in accordance with some implementations. FIG. 2 illustrates three modal control forces for a frog, which correspond to forces that make the frog push down with its two front legs 202, move its two front legs in opposite up/down motions 204, and bend its legs left and right 206. The techniques described herein provide computationally efficient ways to perform animations of a soft body 200, such as illustrated in FIG. 2.

### FIG. 3—Animating Graphical Representation of Soft Body

FIG. 3 illustrates an example method 300 to animate a graphical representation of a soft body in a 3D environment, in accordance with some implementations. Method 300 may begin at block 302.

At block 302, a control space is built. A character may bend in ways a geometry of the character most naturally permits the character to do. To this end, implementations of the method 300 build a control space at block 302, which seeks a set of m control functions that minimizes the Taylor expanded energy. For example, the control space may be built based on eigenfunctions of an elastic energy for the character. Block 302 may be followed by block 304.

At block 304, the control space and a physical space are coupled. The controller interacts with the physical environment through addition of an extra linear term in the energy minimization. Block 304 may be followed by block 306.

At block 306, a soft body is animated. The final soft body controller pipeline becomes simplified. The controller aims to find time-varying state-dependent values for controller activations that achieve specific task objectives.

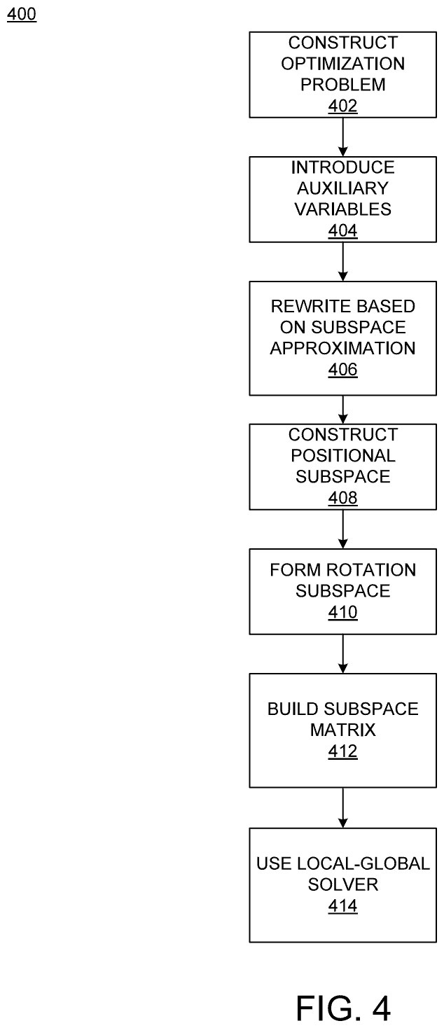

### FIG. 4—Performing Subspace Soft Body Simulation

FIG. 4 illustrates an example method 400 to perform subspace soft body simulation, in accordance with some implementations. Method 400 may begin at block 402.

At block 402, an optimization problem is constructed. Traditional soft body simulations solve an elastodynamic optimization problem for the per-timestep displacement u: argminᵤ E(u,r(u),c(u)) where r(u) and c(u) are forces that arise from rotational stresses (forces occurring within the soft body) and contact forces (forces incident upon the soft body from one or more other bodies that are part of the virtual environment), respectively. These terms have been isolated into this equation as they frequently have a non-linear relationship to u. U is the optimization variable. In implementations, it is the vertex location of the reduced subspace. Block 402 may be followed by block 404.

At block 404, auxiliary variables are introduced. To solve this optimization problem, one approach is to introduce auxiliary variables as degrees of freedom for these non-linear terms: argmin_{u,r,c} E(u,r,c) s.t. r=r(u) c=c(u). Here, r(u) are per-tetrahedral rotations, whereas c(u) are contact forces. In the various equations, “s.t.” stands for “such that.” This optimization problem can then be solved via a local-global solver, where one implementation disclosed herein solves for one degree of freedom at a time, while fixing the other degrees of freedom, and iterating to solve the optimization problem. Block 404 may be followed by block 406.

At block 406, the optimization problem is rewritten based on a subspace approximation. The implementations disclosed herein accelerate this type of simulation for controller exploration by making use of a subspace approximation for three sets of degrees of freedom: u=Bz, r=Gw, c=Dq. The optimization problem above can then be rewritten entirely in terms of these reduced space degrees of freedom: argmin_{z,w,q} E(z,w,q) s.t. w=w(z) q=q(z). This is the same equation as before when minimizing E(u,r,c) for the variables u, r, c, except that it uses the variables z, w, q to approximate variables u, r, c to define the equation.

The subspaces used herein are built entirely from the resting geometry of the mesh, involving no additional user input. Block 406 may be followed by block 408.

At block 408, a positional subspace is constructed. A positional subspace B is a linear blend skinning subspace and may be constructed by randomly sampling point handles about the mesh and performing a heat-diffusion from each handle to obtain skinning weights associated with the soft body. Block 408 may be followed by block 410.

At block 410, a rotation subspace is constructed. A rotation subspace G is formed by clustering tetrahedra in the positional subspace B together using k-means clustering on the positional subspace B, where tetrahedra in each cluster share the same rotation matrix. Block 410 may be followed by block 412.

At block 412, a subspace matrix is built. A subspace matrix D is a selection matrix that slices out randomly sampled point vertices that are the only vertices used to detect and resolve collisions. Block 412 may be followed by block 414.

At block 414, a local-global solver is used. While this specific subspace configuration may be used for locomotion tasks, there are many ways to extend, modify, or change individual components of each of these subspaces that may be better suited for different tasks. Building a physics subspace may be well suited to the controller task being trained for and may play a role on the type of controller to obtain (and in fact, some implementations can obtain the articulated rigid body case as a very specific choice of the physical subspace).

While a local-global solver may be used for solving the soft-body physics, many different soft body simulators exist with a wide range of properties. In some implementations, a solver is selected that is integrable with the subspace and permits the use of the same precomputed quadratic Hessian term in the optimization. With the progress of simulation, implementations of the methodology disclosed herein are easily adaptable to other reduced space physics solvers. After block 414, the soft body deformation is complete.

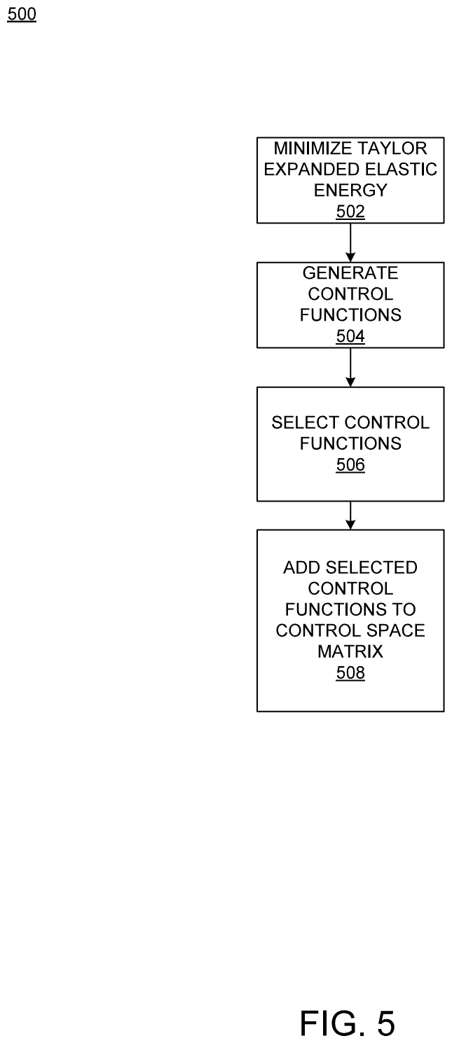

### FIG. 5—Building a Control Space

FIG. 5 illustrates an example method 500 to build a control space, in accordance with some implementations. Method 500 may begin at block 502.

At block 502, a Taylor expanded elastic energy is minimized. A character may bend in ways the geometry of the character most naturally permits the character to do. To this end, implementations of the method 500 build a control space at 502, which seeks a set of m control functions that minimizes the Taylor expanded elastic energy: argmin_{f}_{ᵢ} fᵢ^{T}Hfᵢ s.t. fᵢM fⱼ=δᵢⱼ, where the constraint enforces a non-null solution, and that the control functions be orthogonal to each other. Here, fᵢ is the i^{th} control function and the 8 symbol means that all control functions have a magnitude of 1, but are also orthogonal to each other. Block 502 may be followed by block 504.

At block 504, control functions are generated The resulting forces f₁, . . . , fₘ form a basis for the control space, The resulting forces f₁, . . . , fₘ form a basis for the control space. Block 504 may be followed by block 506.

At block 506, control functions are selected. The user may then select which of these forces are to be used with respect to that control space to achieve animation. Block 506 may be followed by block 508.

At block 508, selected control functions are added to a control space matrix. Once the control functions are selected, they are placed as the columns of the control space matrix K: K=[f₁, . . . , fₘ].

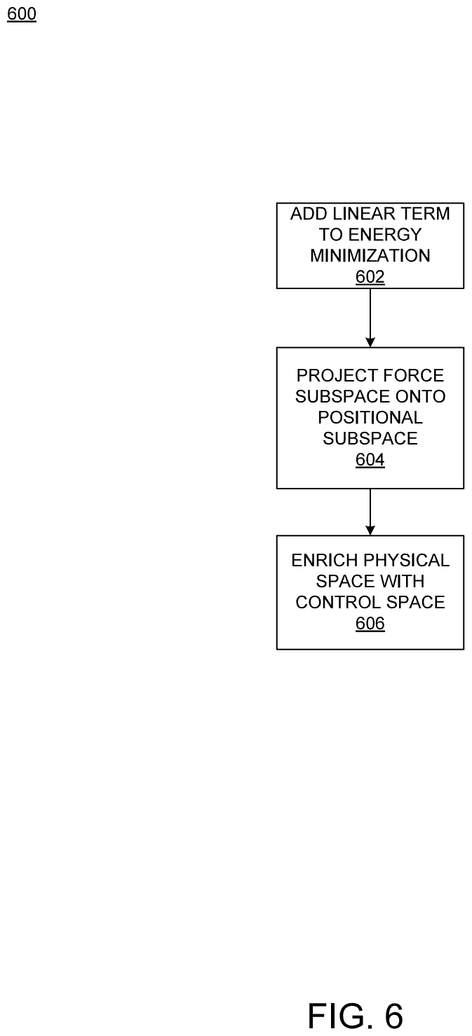

FIG. 6—Coupling Control Space with Physical Space

FIG. 6 illustrates an example method 600 to couple the control space with the physical space, in accordance with some implementations. Method 600 may begin at block 602.

At block 602, a linear term is added to the energy minimization equation. For example, the controller interacts with the physical environment through the addition of an extra linear term in the energy minimization equation: argmin_{z,w,q} E(z,w,q)+z^{T} BMKg s.t. w=w(z) q=q(z). Here, E(z,w,q) is the standard physical energy, but the additional term adds an energy that actuates the character. B is the subspace used for simulation. M is the mass matrix. K is the subspace used for control, selected by the user. Here, g represents how much the controller activates each of the precomputed set of modal forces. Block 602 may be followed by block 604.

At block 604, a force subspace is projected onto a positional subspace. The matrix BMK projects the force subspace to its effect in the positional subspace (and assumes the columns of space B are mass-orthogonal). Block 604 may be followed by block 606.

At block 606, a physical space is enriched with a control space. The physical space may be enriched with control signals obtained from energy minimization in the subspace. To ensure that the force Kg is representable in the space B (as included in argmin_{z,w,q} E(z,w,q)+z^{T} BMKg s.t. w=w(z) q=q(z)), the physical space may be enriched with the control space K, for example by coupling the control space and the physical space. Not doing so may lead to cases of forces being unable to properly communicate their impact on the physical space.

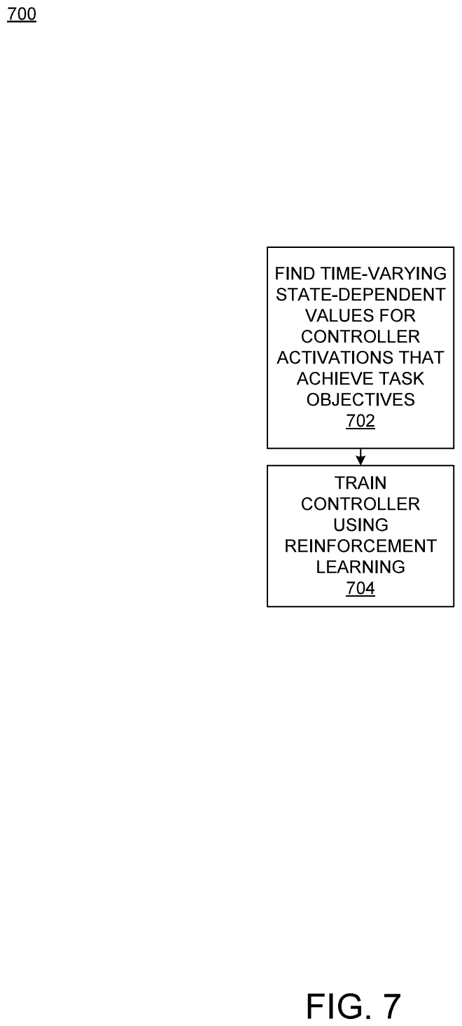

### FIG. 7—Training a Controller

FIG. 7 illustrates an example method 700 to train a controller, in accordance with some implementations. Method 700 may begin at block 702.

At block 702, time-varying state-dependent values for controller activations that achieve task objectives are found. The final soft body controller pipeline becomes simplified. The controller aims to find the time-varying state-dependent values for g that achieve specific task objectives set by the user. Block 702 may be followed by block 704.

At block 704, a controller of the controller pipeline may be trained using reinforcement learning. This controller can be trained very quickly in an unsupervised manner using any Reinforcement Learning technique. For example, an agent may take actions associated with state changes where these actions are associated with rewards, and these rewards may cause the agent to be trained over time to prefer actions that provide better results. Once trained, the controller may be used to effectively animate the soft body.

Implementations disclosed herein can be used for a wide range of tasks, performed by animators and simulation engines alike.

The techniques enable generation of intuitive motions that satisfy a user objective. Using certain objectives, a user may easily be able to generate forward motion, jumping motions, as well as finer details such as grasping, climbing and swimming.

Because the control space is treated as a physical quantity, and is optimized in a physically simulated environment, the generated animations are dynamically able to respond to dynamically changing environments, such as obstacles being thrown at a character, or otherwise.

Physical limits of the animated model can be tuned to give different characteristics in the resulting motion, such as characters that have stronger or weaker limbs, characters that have rigid and soft components to them, or characters that resist bending.

The techniques can accommodate user input at every level, a user can provide an animation of part of a character, and the techniques are able to determine the motion of other parts of the character to achieve an objective. For example, a user can specify the motion of the front legs of an animal, and the techniques can figure out how to move the back legs of the animal such that the animal moves forward without falling.

Similarly, users can provide exemplary motions from a camera recording and the techniques can be trained to identify actuations that provide a plausible reconstruction of that motion for soft-body creatures and characters.

In addition to a single character, the techniques are generalizable to multiple characters, leading to animation synthesis for crowd movements.

The techniques can easily be used to fine-tune input animations provided by a user to that they may be more realistic. Fine tune existing animations that assume rigid bodies. The techniques are able to refine the input rigid body animation by incorporating soft body physics to make movement of a body more realistic.

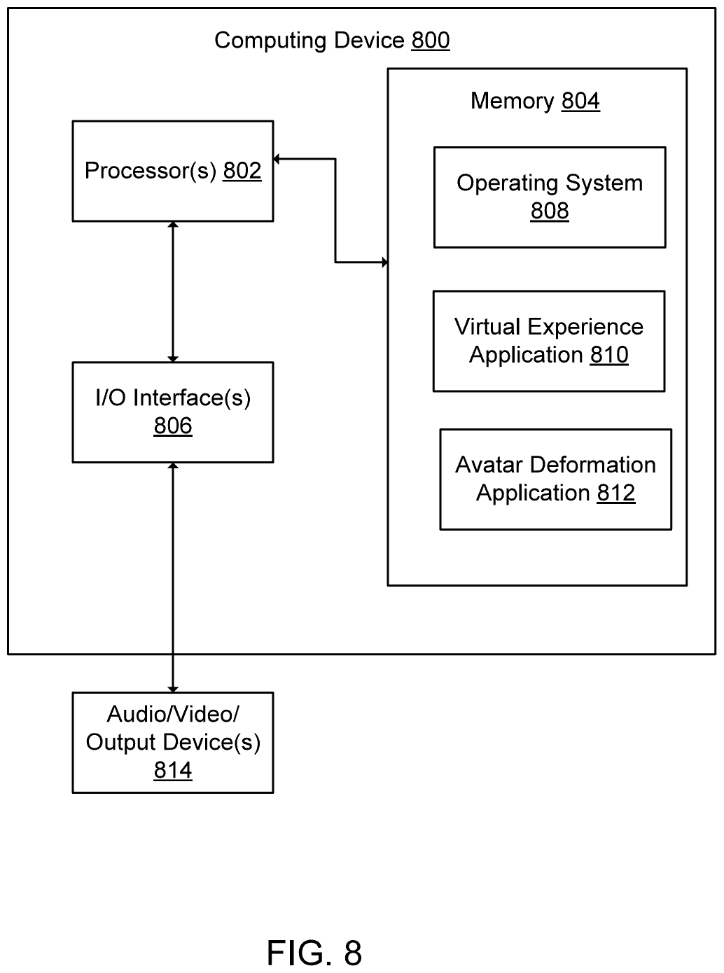

### FIG. 8—Example Computing Device

FIG. 8 is a block diagram that illustrates an example computing device 800 which may be used to implement one or more features described herein, in accordance with some implementations. In one example, computing device 800 may be used to implement a computer device (e.g., 102 and/or 110 of FIG. 1), and perform appropriate method implementations described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 800 includes a processor 802, a memory 804, input/output (I/O) interface 806, and audio/video input/output devices 814.

Processor 802 can be one or more processors and/or processing circuits to execute program code and control basic operations of the computing device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in computing device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the computing device 800 by the processor 802, including an operating system 808, a virtual experience application 810, an avatar deformation application 812, and other applications (not shown). In some implementations, virtual experience application 810 and/or avatar deformation application 812 can include instructions that enable processor 802 to perform the functions (or control the functions of) described herein, e.g., some or all of the methods described with respect to FIGS. 3-7.

For example, applications 810 can include an avatar deformation application 812, which as described herein can animate soft deformations of 3D bodies within an online virtual experience server (e.g., 102). Elements of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the computing device 800 with other systems and devices. For example, network communication devices, storage devices (e.g., memory and/or data store 120), and input/output devices can communicate via I/O interface 806. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 814 can include a user input device (e.g., a mouse, etc.) that can be used to receive user input, a display device (e.g., screen, monitor, etc.) and/or a combined input and display device, which can be used to provide graphical and/or visual output.

For ease of illustration, FIG. 8 shows one block for each of processor 802, memory 804, I/O interface 806, and software blocks of operating system 808, virtual experience application 810, and avatar deformation application 812. These blocks may represent one or more processors or processing circuitries, operating systems, memories, I/O interfaces, applications, and/or software engines. In other implementations, computing device 800 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 814, for example, can be connected to (or included in) the computing device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 300, 400, 500, 600, and 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method to animate a soft body, the computer-implemented method comprising:
building a control space having information representative of forces corresponding to natural movement of the soft body, wherein the soft body is part of a virtual environment;
coupling the control space and a physical space to define a controller pipeline that performs animation of the soft body;
performing the animation of the soft body using the controller pipeline; and
causing the animation of the soft body to be displayed in a user interface of the virtual environment.

2. The computer-implemented method of claim 1, wherein building the control space is based on eigenfunctions of elastic energy of the soft body.

3. The computer-implemented method of claim 1, wherein the forces corresponding to the natural movement of the soft body are forces that arise from rotational stresses within the soft body.

4. The computer-implemented method of claim 1, wherein the forces corresponding to the natural movement of the soft body are contact forces applied to the soft body from one or more other bodies that are part of the virtual environment.

5. The computer-implemented method of claim 1, wherein building the control space comprises simulating the forces corresponding to the natural movement of the soft body by solving an elastodynamic optimization problem using auxiliary variables as degrees of freedom.

6. The computer-implemented method of claim 5, wherein the simulating comprises:
using a subspace approximation for the degrees of freedom; and
rewriting the elastodynamic optimization problem in terms of reduced space degrees of freedom of the subspace approximation.

7. The computer-implemented method of claim 6, wherein the simulating further comprises, after the rewriting, solving the elastodynamic optimization problem using a local-global solver that solves for one degree of freedom at a time while other degrees of freedom in the subspace approximation are fixed.

8. The computer-implemented method of claim 6, wherein the subspace approximation comprises a positional subspace, a rotation subspace, and a subspace matrix.

9. The computer-implemented method of claim 8, wherein the positional subspace is a linear blend subspace, and further comprising constructing the positional subspace by sampling point handles from a mesh of the soft body and performing a heat-diffusion from each point handle to obtain skinning weights associated with the soft body.

10. The computer-implemented method of claim 8, further comprising forming the rotation subspace by clustering tetrahedra in the positional subspace together using k-means clustering on the positional subspace, wherein tetrahedra in each cluster share a same rotation matrix.

11. The computer-implemented method of claim 8, wherein the subspace matrix is a selection matrix that slices out randomly sampled point vertices of the soft body, wherein the randomly sampled point vertices are used to detect and resolve collisions during the animation of the soft body.

12. The computer-implemented method of claim 8, wherein coupling the control space and the physical space comprises representing the physical space by addition of a linear term in an energy minimization equation when solving the elastodynamic optimization problem, the linear term comprising a matrix used to project a force subspace to corresponding effects of the force subspace on the positional subspace.

13. The computer-implemented method of claim 1, wherein the controller pipeline is associated with time-varying state-dependent values for controller activations that achieve specific animation task objectives and wherein a controller of the controller pipeline is trained using reinforcement learning to achieve the specific animation task objectives when performing animation of the soft body.

14. The computer-implemented method of claim 1, wherein the control space is built based on control functions that minimize a Taylor expanded energy of the soft body and that generate a non-null set of solution control functions that are orthogonal to each other.

15. The computer-implemented method of claim 14, wherein the control space is built using the solution control functions to define forces that form a basis of the control space based on a user selection of one or more selected forces of the forces that form the basis of the control space, wherein the selected forces are placed as columns of a control space matrix that represents the control space.

16. A non-transitory computer-readable medium with instructions stored thereon that, responsive to execution by a processing device, causes the processing device to perform operations comprising:
building a control space having information representative of forces corresponding to natural movement of a soft body, wherein the soft body is part of a virtual environment;
coupling the control space and a physical space to define a controller pipeline that performs animation of the soft body;
performing the animation of the soft body using the controller pipeline; and
causing the animation of the soft body to be displayed in a user interface of the virtual environment.

17. The non-transitory computer-readable medium of claim 16, wherein building the control space is based on eigenfunctions of elastic energy of the soft body.

18. The non-transitory computer-readable medium of claim 16, wherein building the control space comprises simulating the forces corresponding to the natural movement of the soft body by solving an elastodynamic optimization problem using auxiliary variables as degrees of freedom.

19. A system, comprising:
a memory with instructions stored thereon; and
a processing device, coupled to the memory, the processing device configured to access the memory and execute the instructions, wherein the instructions cause the processing device to perform operations comprising:
building a control space having information representative of forces corresponding to natural movement of a soft body, wherein the soft body is part of a virtual environment;
coupling the control space and a physical space to define a controller pipeline that performs animation of the soft body;
performing the animation of the soft body using the controller pipeline; and
causing the animation of the soft body to be displayed in a user interface of the virtual environment.

20. The system of claim 19, wherein building the control space is based on eigenfunctions of elastic energy of the soft body.
